(19) United States
(12) Patent Application Publication
(10) Pub. No.: US 2004/0008785 A1
(43) Pub. Date: Jan. 15, 2004

(54) L-frames with both filtered and unfilterd regions for motion comensated temporal filtering in wavelet based coding

(75) Inventors: Deepak S. Turaga, Croton On Hudson, NY (US); Mihaela Van Der Schaar, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/264,901

(22) Filed: Oct. 4, 2002

Related U.S. Application Data
(60) Provisional application No. 60/395,921, filed on Jul. 15, 2002.

(51) Int. Cl. H04N 7/12

(52) U.S. Cl. 375/240.19

(57) ABSTRACT

The present invention is directed to a method and device for encoding video. According to the present invention, a first region in a first frame is matched to a second region in a second frame. A first partially encoded frame is produced including a difference between pixel values of the first and second region. A second partially encoded frame is produced including pixel values of either the first or second region. Further, the first and second partially encoded frame is transformed into wavelet coefficients.

### CROSS REFERENCE TO RELATED APPLICATIONS

The present application claims the benefit of U.S. Provisional Application Serial No. 60/395,921, filed on Jul. 15, 2002, the teachings of which are incorporated herein by reference.

### BACKGROUND OF THE INVENTION

The present invention relates generally to video compression, and more particularly, to wavelet based coding utilizing motion compensated temporal filtering that produces L-frames with both filtered and unfiltered regions.

A number of the current video coding algorithms are based on motion compensated predictive coding, which are considered hybrid schemes. In such hybrid schemes, temporal redundancy is reduced using motion compensation, while spatial redundancy is reduced by transform coding the residue of motion compensation. Commonly used transforms include the discrete cosine transform (DCT) or sub-band/wavelet decompositions. Such schemes, however, lack flexibility in terms of providing true scalable bit streams.

Another type of scheme known as 3D sub-band/wavelet (hereafter “3D wavelet”) based coding has gained popularity especially in the current scenario of video transmission over heterogeneous networks. These schemes are desirable in such application since very flexible scalable bit streams and higher error resilience is provided. In 3D wavelet coding, the whole frame is transformed at a time instead of block by block as in DCT based coding.

One component of 3D wavelet schemes is motion compensated temporal filtering (MCTF), which is performed to reduce temporal redundancy. An example of MCTF is described in an article entitled “Motion-Compensated 3-D Subband Coding of Video”, IEEE Transactions On Image Processing, Volume 8, No. 2, February 1999, by Seung-Jong Choi and John Woods, hereafter referred to as “Woods”.

In Woods, frames are filtered temporally in the direction of motion before the spatial decomposition is performed. During the temporal filtering, some pixels are either not referenced or are referenced multiple times due to the nature of the motion in the scene and the covering/uncovering of objects. Such pixels are known as unconnected pixels and require special handling, which leads to reduced coding efficiency. An example of unconnected and connected pixels is shown in FIG. 1, which was taken from Woods.

### SUMMARY OF THE INVENTION

The present invention is directed to a method and device for encoding video. According to the present invention, a first region in a first frame is matched to a second region in a second frame. A first partially encoded frame is produced including a difference between pixel values of the first and second region. A second partially encoded frame is produced including pixel values of either the first or second region. Further, the first and second partially encoded frame is transformed into wavelet coefficients.

In one example, the second partially encoded frame including pixel values of either the first or second region is produced if the quality of match between the first and second region is greater than a predetermined threshold. In another example, the second partially encoded frame including pixel values of either the first or second region is produced if a number of bits to encode the second partially decoded frame is less than if an average of pixel values of the first and second region is included in the second partially encoded frame.

The present invention is directed to a method and device for decoding a bit-stream. According to the present invention, the bit-stream is entropy decoded to produce wavelet coefficients. The wavelet coefficients are transformed into a first partially decoded frame including a filtered region and a second partially decoded frame including an unfiltered region. A first frame is produced including the pixel values of the filtered region and unfiltered region combined by either an addition or subtraction. Further, a second frame is produced including the pixel values of the unfiltered region.

### BRIEF DESCRIPTION OF THE DRAWINGS

Referring now to the drawings were like reference numbers represent corresponding parts throughout:

FIG. 1 is a diagram illustrating aspects of a known motion compensated temporal filtering technique;

FIG. 2 is a diagram illustrating one example of temporal filtering according to the present invention;

FIG. 3 is a block diagram of one example of an encoder according to the present invention;

FIG. 4 a block diagram illustrating one example of a 2D wavelet transform;

FIG. 5 is one example of a decoder according to the present invention; and

FIG. 6 is one example of a system according to the present invention.

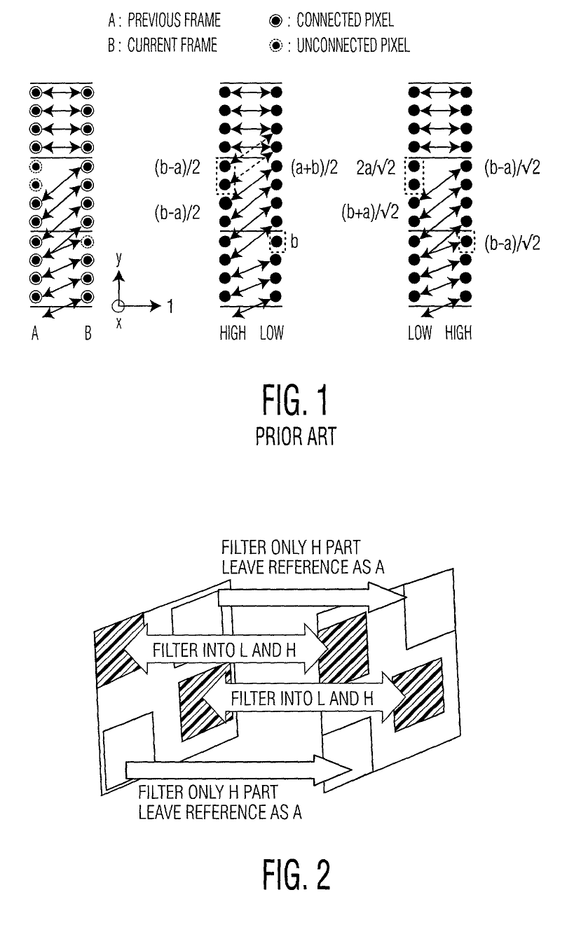

### DETAILED DESCRIPTION

As previously described, one component of 3D wavelet schemes is motion compensated temporal filtering (MCTF), which is performed to reduce temporal redundancy. In conventional MCTF, the frames are filtered in pairs. In particular, each pair of frames (A,B) are filtered into a pair of L and H-frames, using the motion vectors (v_{y,}vₓ) matching similar regions in each pair of frames, as follows:

L(y+v_{y},x+vₓ)=c₁(A(y+v_{y},x+vₓ)+B(y,x)) (1)

H(y,x)=c₂(B(y,x)−A(y+v_{y},x+vₓ)) (2)

In equation 1, L corresponds to the scaled average of each pair, where c₁ represents the scaling factor. In equation 2, H corresponds to the scaled difference of each pair, where c₂ represents the scaling factor. Since the L-frames represent temporally averaged frames, usually the L-frames are usually only displayed if the video is decoded at a lower frame rate. Therefore, the L-frames should be of a good quality since any artifacts produced in the decoded L-frames may lead to poor video quality at lower frame rates.

The quality of L-frames is usually quite good when the quality of the motion estimation is good, i.e. a good match is found. However, there are cases in video sequences where a good match may not be found for regions between two frames. Such cases include scene changes, rapid motion or covering and uncovering of objects in a particular scene. Thus, according to the present invention, the portions of L-frames corresponding to poor matches are left unfiltered, which are defined as A-regions. This enables the visual quality of these regions not be affected even though a good match cannot be found. Further, it is also possible that by not filtering across poorly matched regions the coding efficiency may be improved.

One example of temporal filtering according to the present invention is shown in FIG. 2 In this example, two regions (shaded) are shown filtered so that L and H-regions are produced. Further, two other regions (un-shaded) are shown filtered so that A and H-regions are produced. As previously described, an A-region is a portion of a frame that was left unfiltered. Since the L-regions are scaled during filtering, it may also be necessary to scale the unfiltered A-regions in order to have the same magnitudes. This scaling of the A-regions may be expressed as follows:

L(y+v_{y},x+vₓ)=c₃(A(y+v_{y},x+vₓ)) (3)

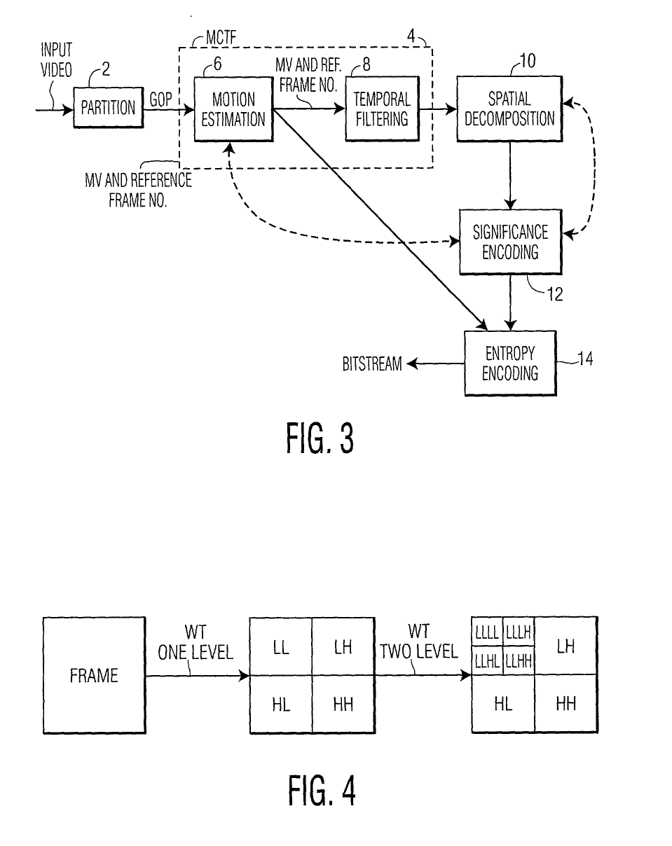

One example of encoder according to the present invention is shown in FIG. 3. As can be seen, the encoder includes a partitioning unit 2 for dividing the input video into a group of pictures (GOP), which are encoded as a unit. According to the present invention, the partition unit 2 operates so that the GOP includes a predetermined number of frames or are determined dynamically during operation based on parameters such as bandwidth, coding efficiency, and the video content. For instance, if the video consists of rapid scene changes and high motion, it is more efficient to have a shorter GOP, while if the video consists of mostly stationary objects, it is more efficient to have a longer GOP.

As can be seen, a MCTF unit 4 is included that is made up of a motion estimation unit 6 and a temporal filtering unit 8. During operation, the frames of each GOP will be processed in pairs, where each of the pairs include a source frame and a reference frame. Thus, the motion estimation unit 6 will match regions in each of the source frames to similar regions in each of the reference frames. In one example, the motion estimation unit 6 will perform backward prediction. Thus, in this example, the source frame will be a later frame and the reference frame will be an earlier frame. In another example, the motion estimation unit 6 will perform forward prediction. Thus, in this example, the source frame will be an earlier frame and the reference frame will be a later frame. As a result of the above described matching, the motion estimation unit 6 will provide a motion vector MV and a frame number for each region matched in the current frame being processed.

During operation, the temporal filtering unit 8 removes temporal redundancies between each pair of frames. In order to perform this, the temporal filtering unit 8 retrieves each of the two corresponding regions matched for each pair of frames according to the motion vectors and frame reference numbers provided by the motion estimation unit 6. The temporal filtering unit 8 will then produce a L and H-frame for each pair of frames being processed.

In order to produce a H-frame, the temporal filtering unit 8 calculates the difference between the pixel values for each the two corresponding matched regions for each pair of frames. Preferably, the difference is then multiplied by a scaling factor. Examples of a suitable scaling factor would include the inverse of the square root of two (1/√2).

In order to produce a L-frame, the temporal filtering unit 8 will determine for each of the two corresponding matched regions in each pair of frames whether it should be an unfiltered A-region or should be filtered as an L-region. For each of the two corresponding matched regions that is determined to be a L-region, the temporal filtering unit 8 calculates the average of the pixel values of the two regions. Preferably, the average of these two regions is then multiplied by a scaling factor. Examples of a suitable scaling factor would include the square root of two (√2).

For each of the two corresponding matched regions that is determined to be an A-region, the temporal filtering unit 8 will select pixel values of one of the two regions to be included in each L-frame. Preferably, the temporal filtering unit 8 will select the region from the reference frame. However, according to the present invention, the region may also be selected from the source frame. In order to ensure proper decoding, it may be necessary to indicate to a decoder whether each A-region was selected from either the reference frame or source frame. This may be accomplished by some kind of flag or header that is associated with each L-frame. Further, it is also preferable that that the region selected be multiplied by a scaling factor. Examples of a suitable scaling factor would include the inverse of the square root of two (1/√2).

As described above, the temporal filtering unit 8 will determine for each of the two corresponding matched regions in each pair of frames whether it should an A-region or should be filtered as an L-region. According to the present invention, this may be done in a number of different ways. In one example, this will be determined based on the quality of the match between the two corresponding regions. The quality of match may be determined by using a quality of match indication. Examples of a suitable quality of match indication include the mean absolute difference (MAD) or the mean squared error (MSE) between the two corresponding matched regions. The MAD between two N×N regions xᵢⱼ and yᵢⱼ is calculated by the mean of the absolute pixel difference, as follows:

$$MAD = \frac{1}{{N}^{2}} {\sum }_{i = 1}^{N} {\sum }_{j = 1}^{N} \vert {x}_{ij} - {y}_{ij} \vert \qquad ( 4 )$$

According to Equation 4, a smaller the MAD value implies a smaller difference between the two regions and it may be concluded that the two regions are better matched. This value is sequence dependent, with low motion sequences having smaller MAD values on the average, and high motion sequences having larger average MADs. On average, a reasonably good quality match has an MAD value less than five (5). Thus, this threshold value may be used to determine whether each of the two corresponding matched regions is a good a match or not. If the MAD value is less than five (5), then those particular two corresponding matched regions will be filtered as an L-region. If the MAD value is greater than this threshold, then those particular two matched regions will be unfiltered as an A-region.

In another example, it will be determined whether each of the two corresponding matched regions should be an A-region or should be filtered as an L-region based on the number of bits it takes to code the L-frames. In particular, for each of the two corresponding matched regions, the number of bits required to code each L-frame with and without an A-region will be calculated. If the number of bits is less with an A-region, then those particular two corresponding matched regions will be left unfiltered as an A-region. If the number of bits is not less with an A-region, then those particular corresponding matched regions will be filtered as an L-region. In this example, coding efficiency may be increased.

The number of bits it takes to code the L-frames may be affected by the particular entropy encoding technique used. For example, the embedded zerotree block coding (EZBC) technique is among the more popular entropy coding techniques for wavelet based video coders. One of the features with such a scheme is that it requires fewer bits to code regions with localized data, as opposed to regions with data spread out. If the transformed coefficients (after temporal filtering and the spatial decomposition) are very clustered, with many large areas with very few non-zero coefficients, then EZBC requires less bits to compressing the data. On the other hand, if the coefficients are more spread out, then EZBC requires more bits. Therefore, the determination of whether each of the two corresponding matched regions be left unfiltered as an A-region or filtered as a L-region may differ depending on the entropy encoding technique used.

The above-described MCTF also may produce unconnected pixels. Therefore, the temporal filtering unit 8 will handle these unconnected pixels, as described in Woods.

As can be seen, a spatial decomposition unit 10 is included to reduce the spatial redundancies in the frames provided by the MCTF unit 4. During operation, the frames received from the MCTF unit 4 are transformed into wavelet coefficients according to a 2D wavelet transform. There are many different types of filters and implementations of the wavelet transform.

One example of a suitable 2D wavelet transform is shown in FIG. 4. As can be seen, a frame is decomposed, using wavelet filters into low frequency and high frequency sub-bands. Since this is a 2-D transform there are three high frequency sub-bands (horizontal, vertical and diagonal). The low frequency sub-band is labeled the LL sub-band (low in both horizontal and vertical frequencies). These high frequency sub-bands are labeled LH, HL and HH, corresponding to horizontal high frequency, vertical high frequency and both horizontal and vertical high frequency. The low frequency sub-bands may be further decomposed recursively. In FIG. 3, WT stands for Wavelet transform. There are other well known wavelet transform schemes described in a book entitled “A Wavelet Tour of Signal Processing”, by Stephane Mallat, Academic Press, 1997.

Referring back to FIG. 3, the encoder may also include a significance encoding unit 12 to encode the output of the spatial decomposition unit 10 according to significance information. In this example, significance may mean magnitude of the wavelet coefficient, where larger coefficients are more significant than smaller coefficients. In this example, the significance encoding unit 10 will look at the wavelet coefficients received from the spatial decomposition unit 10 and then reorder the wavelet coefficients according to magnitude. Thus, the wavelet coefficients having the largest magnitude will be sent first. One example of significance encoding is Set Partitioning in Hierarchical Trees (SPIHT). This is described in the article entitled “A New Fast and Efficient Image Codec Based on Set Partitioning in Hierarchical Tress,” by A. Said and W. Pearhnan, IEEE Transactions on Circuits and Systems for Video Technology, vol. 6, June 1996.

As can be seen from FIG. 3, dotted lines are included to indicate dependency between some of the operations. In one instance, the motion estimation 6 is dependent on the nature of the significance encoding 12. For example, the motion vectors produced by the motion estimation may be used to determine which of the wavelet coefficients are more significant. In another instance, the spatial decomposition 10 may also be dependent on the type of the significance encoding 12. For instance the number of levels of the wavelet decomposition may be related to the number of significant coefficients.

As can be further seen, an entropy encoding unit 14 is included to produce the output bit-stream. During operation, an entropy coding technique is applied to encode the wavelet coefficients into an output bit-stream. The entropy encoding technique is also applied to the motion vectors and frame numbers provided by the motion estimation unit 6. This information is included in the output bit-stream in order to enable decoding. Examples of a suitable entropy encoding technique include variable length encoding and arithmetic encoding.

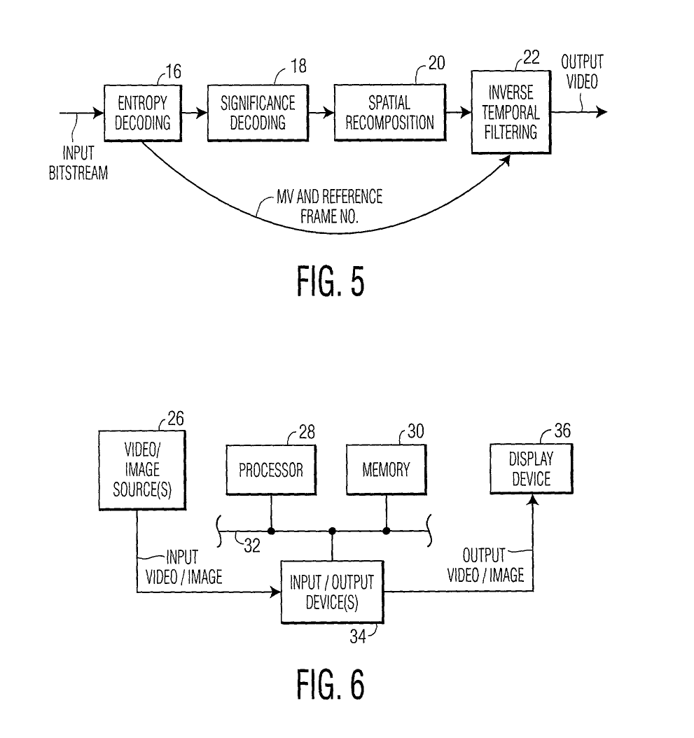

One example of a decoder according to the present invention is shown in FIG. 5. As previously described in regard to FIG. 3, the input video is divided into GOPs and each GOP is encoded as a unit. Thus, the input bit-stream may include one or more GOPs that will also be decoded as a unit. The bit-stream will also include a number of motion vectors MV and frame numbers that correspond to each frame in the GOP that was previously motion compensated temporally filtered.

As can be seen, the decoder includes an entropy decoding unit 16 for decoding the incoming bit-stream. During operation, the input bit-stream will be decoded according to the inverse of the entropy coding technique performed on the encoding side. This entropy decoding will produce wavelet coefficients that correspond to each GOP. Further, the entropy decoding produces a number of motion vectors and frame numbers that will be utilized later. A significance decoding unit 18 is included in order to decode the wavelet coefficients from the entropy decoding unit 16 according to significance information. Therefore, during operation, the wavelet coefficients will be ordered according to the correct spatial order by using the inverse of the technique used on the encoder side.

As can be further seen, a spatial recomposition unit 20 is included to transform the wavelet coefficients from the significance decoding unit 18 into partially decoded frames. During operation, the wavelet coefficients corresponding to each GOP will be transformed according to the inverse of the 2D wavelet transform performed on the encoder side. This will produce partially decoded frames that have been motion compensated temporally filtered according to the present invention. As previously described, the motion compensated temporal filtering produces a pair of H and L-frames for each pair of frames processed. Further, according to the present invention, the L-frames may include both unfiltered A-regions and filtered L-regions, as previously described.

An inverse temporal filtering unit 22 is included to reconstruct the partially decoded frames from the spatial recomposition unit 20. During operation, the inverse temporal filtering unit 22 processes each pair of H and L-frames included in each GOP, as follows. First, corresponding regions in each pair of H and L-frames are retrieved according to the motion vectors and frame numbers provided by the entropy decoding unit 16. According to the present invention, each of the corresponding regions retrieved will include either an L-region or a A-region from an L-frame and a region from an H-frame. As previously described, the A-region represents the unfiltered pixel values of one of two corresponding matched regions between a pair of frames, the L-region represents the average of pixel values of the two corresponding matched regions and the region from the H-frame represents the difference between the two corresponding matched regions. Further, each of the retrieved corresponding regions are divided by the same scaling factor used on the encoder side.

For each L-region included in the L-frames, a sum and difference is calculated for the pixel values of each L-region and the corresponding region in the H-frame. Each sum and difference is then divided by another scaling factor. An example of a suitable scaling factor would be a value of two (2). Each scaled sum and difference is then placed in the appropriate reconstructed frame.

For each A-region included in the L-frames, it will be passed along unchanged to the appropriate reconstructed frame after being initially scaled, as described above. As previously described, each L-frame may have an associated header or flag that indicates whether a particular A-region was selected from either a reference frame or source frame. Thus, each A-region may be placed in the appropriate reconstructed frame according to the information in the associated header or flag. Alternatively, the A-region may be placed in the appropriate frame according to a predetermined convention. For example, it could be decided to select all A-regions from a reference frame for the whole video sequence.

Further, the pixel values for each A-region will also be combined with pixel values from the corresponding region in the H-frame. According to the present invention, combining these pixel values may be done by either an addition or subtraction. For example, if backward prediction was used on the encoder side and the A-region originated from a reference frame, a subtraction may be preferable. Alternatively, if backward prediction was used on the encoder side and the A-region originated from a source frame, an addition may be preferable. Each of the values derived from combining the A-region with the region in the H-frame is then placed in the appropriate reconstructed frame.

One example of a system in which the wavelet based coding utilizing motion compensated temporal filtering that produces L-frames with both filtered and unfiltered regions according to the present invention may be implemented is shown in FIG. 6. By way of example, the system may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system includes one or more video sources 26, one or more input/output devices 34, a processor 28, a memory 30 and a display device 36.

The video/image source(s) 26 may represent, e.g., a television receiver, a VCR or other video/image storage device. The source(s) 26 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 34, processor 28 and memory 30 communicate over a communication medium 32. The communication medium 32 may represent, e.g., a bus, a communication network, one or more internal connections of a circuit, circuit card or other device, as well as portions and combinations of these and other communication media. Input video data from the source(s) 26 is processed in accordance with one or more software programs stored in memory 30 and executed by processor 28 in order to generate output video/images supplied to the display device 36.

In particular, the software programs stored on memory 30 includes the wavelet based coding as described previously in regard to FIGS. 3 and 5. In this embodiment, the wavelet based coding is implemented by computer readable code executed by the system. The code may be stored in the memory 30 or read/downloaded from a memory medium such as a CD-ROM or floppy disk. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

What is claimed is:

1. A method for encoding video, comprising the steps of:
matching a first region in a first frame to a second region in a second frame;
producing a first partially encoded frame including a difference between pixel values of the first and second region;
producing a second partially encoded frame including pixel values of either the first or second region; and
transforming the first and second partially encoded frame into wavelet coefficients.

2. The method of claim 1, which further includes encoding the wavelet coefficients according to significance information.

3. The method of claim 1, which further includes entropy encoding the wavelet coefficients.

4. The method of claim 1, which further includes multiplying the difference between pixel values of the first and second region by a scaling factor.

5. The method of claim 1, which further includes multiplying the pixel values of either the first or second region by a scaling factor.

6. The method of claim 1, which further includes:
matching a third region in the first frame to a fourth region in the second frame;
including an average of pixel values of the third and fourth region in the second partially encoded frame.

7. The method of claim 6, which further includes multiplying the average of pixel values of the third and fourth region by a scaling factor.

8. The method of claim 1, wherein the producing the second partially encoded frame including pixel values of either the first or second region is performed if a quality of match indication is greater than a predetermined threshold.

9. The method of claim 1, wherein the producing the second partially encoded frame including pixel values of either the first or second region is performed if a number of bits to encode the second partially decoded frame is less than if an average of pixel values of the first and second region is included in the second partially encoded frame.

10. A memory medium including code for encoding video, the code comprising:
a code for matching a first region in a first frame to a second region in a second frame;
a code for producing a first partially encoded frame including a difference between pixel values of the first and second region;
a code for producing a second partially encoded frame including pixel values of either the first or second region; and
a code for transforming the first and second partially encoded frames into wavelet coefficients.

11. A device for encoding video, comprising:
a motion estimation unit matching a first region in a first frame to a second region in a second frame;
a temporally filtering unit for producing a first partially encoded frame including a difference between pixel values of the first and second region and a second partially encoded frame including pixel values of either the first or second region; and
a spatial decomposition unit for transforming the first and second partially encoded frame into wavelet coefficients.

12. A method of decoding a bit-stream, comprising the steps of:
entropy decoding the bit-stream to produce wavelet coefficients;
transforming the wavelet coefficients into a first partially decoded frame including a filtered region and a second partially decoded frame including an unfiltered region:
producing a first frame including the pixel values of the filtered region and unfiltered region combined; and
producing a second frame including the pixel values of the unfiltered region.

13. The method of claim 12, which further includes dividing the filtered region by a scaling factor.

14. The method of claim 12, which further includes dividing the unfiltered region by a scaling factor.

15. The method of claim 12, wherein the pixel values of the filtered region and unfiltered region are combined by a subtraction.

16. The method of claim 12, wherein the pixel values of the filtered region and unfiltered region are combined by an addition.

17. The method of claim 12, wherein the unfiltered region includes pixel values of one of two matched regions.

18. The method of claim 12, wherein the filtered region includes a difference of pixel values from two matched regions.

19. The method of claim 12, which further includes decoding the wavelet coefficients according to significance information.

20. A device for decoding a bit-stream, comprising:
an entropy decoding unit for decoding the bit-stream into wavelet coefficients;
a spatial recomposition unit for transforming the wavelet coefficients into a first partially decoded frame including a filtered region and a second partially decoded frame including an unfiltered region; and
an inverse temporal filtering unit for producing a first frame including the pixel values of the filtered region and unfiltered region combined and a second frame including the pixel values of the unfiltered region.

21. A memory medium including code for decoding a bit-stream, the code comprising:
a code for entropy decoding the bit-stream to produce wavelet coefficients;
a code for transforming the wavelet coefficients into a first partially decoded frame including a filtered region and a second partially decoded frame including an unfiltered region; and
a code for producing a first frame including the pixel values of the filtered region and unfiltered region combined; and
a code for producing a second frame including the pixel values of the unfiltered region.
